(19) United States
(12) Patent Application Publication
(10) Pub. No.: US 2026/0072291 A1
(43) Pub. Date: Mar. 12, 2026

(54) FREEFORM PENTA PRISM COLLIMATOR

(71) Applicant: GOOGLE LLC, Mountain View, CA (US)

(72) Inventors: Ozan CAKMAKCI, San Bruno, CA (US); Shreyas POTNIS, Kitchener (CA); Daniel ADEMA, Kitchener (CA)

(21) Appl. No.: 19/107,430

(22) PCT Filed: Aug. 31, 2022
(86) PCT No.: PCT/US2022/042273

§ 371 Date: Feb. 27, 2025

(51) Int. Cl. G02B 27/30; G02B 1/04; G02B 5/04; G02B 27/01

(52) U.S. Cl. CPC G02B 27/30; G02B 1/045; G02B 27/0172; G02B 5/04; G02B 2027/0178

(57) ABSTRACT

A penta prism collimator having four freeform surfaces that fold the optical path of light received from a microdisplay collimates light for coupling to a waveguide. In some embodiments, the freeform surfaces are toroidal surfaces made from a single injection-molded element, such as a single piece of plastic. The freeform surfaces collimate the light at a variety of distances from an input pupil of a waveguide, allowing for more freedom of placement within a frame of a WHUD.

### BACKGROUND

Augmented reality (AR) eyewear fuses a view of the real world with a heads-up display overlay. Wearable heads-up displays (WHUDs), also referred to as head-mounted displays (HMDs) are wearable electronic devices that use optical combiners to combine real world and virtual images. The optical combiner may be integrated with one or more lenses to provide a combiner lens that may be fitted into a support frame of a WHUD. In operation, the combiner lens provides a virtual display that is viewable by a user when the WHUD is worn on the head of the user.

One class of optical combiner uses one or more waveguides (also termed lightguides) to transfer light. In general, light from a projector, microdisplay, or other light engine of the WHUD enters a waveguide of the combiner through an incoupler, propagates along the waveguide via total internal reflection (TIR), and exits the waveguide through an outcoupler. If a pupil of a user's eye is aligned with one or more exit pupils provided by the outcoupler, at least a portion of the light exiting through the outcoupler will enter the pupil of the user's eye, thereby enabling the user to see a virtual image. Since the optical combiner is substantially transparent, the user will also be able to see the real world.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example head-mounted display (HMD) employing a freeform penta prism collimator that collimates light entering an optical waveguide through which images projected by the HMD are displayed, in accordance with some embodiments.

FIG. 2 shows an example freeform penta prism collimator in accordance with some embodiments.

FIG. 3 shows an example freeform penta prism collimator with a spherical field flattener to increase the field of view in accordance with some embodiments.

FIG. 4 shows an example freeform penta prism collimator without artifact mitigation in accordance with some embodiments.

FIG. 5 shows an example of a display image without artifact mitigation in accordance with some embodiments.

FIG. 6 shows an example freeform penta prism collimator with artifact mitigation in accordance with some embodiments.

FIG. 7 shows an example of a display image with artifact mitigation in accordance with some embodiments.

FIG. 8 shows an example placement of a freeform penta prism collimator within an example HMD in accordance with some embodiments.

FIG. 9 shows an example placement of two freeform penta prism collimators within an example HMD in accordance with some embodiments.

FIG. 10 is a flow diagram of a method of directing light within a freeform penta prism collimator to produce collimated light at an input pupil of a waveguide in accordance with some embodiments.

### DETAILED DESCRIPTION

The development and adoption of wearable electronic display devices have been limited by constraints imposed by the optics, aesthetics, manufacturing process, thickness, field of view (FOV), and prescription lens limitations of the optical systems used to implement existing display devices. For example, the geometry and physical constraints of conventional designs result in displays having relatively small FOVs and relatively thick optical combiners.

For a virtual image displayed at a WHUD to be clear and have a FOV, light generated by the projector, micro-display, or other light engine of the WHUD is collimated (i.e., made to have parallel light beams) before the light enters a waveguide of the combiner through an incoupler. Collimation of light can be achieved with one or more collimating lenses; however, collimating lenses that direct light along an unfolded path result in a less compact design and a more complex manufacturing process.

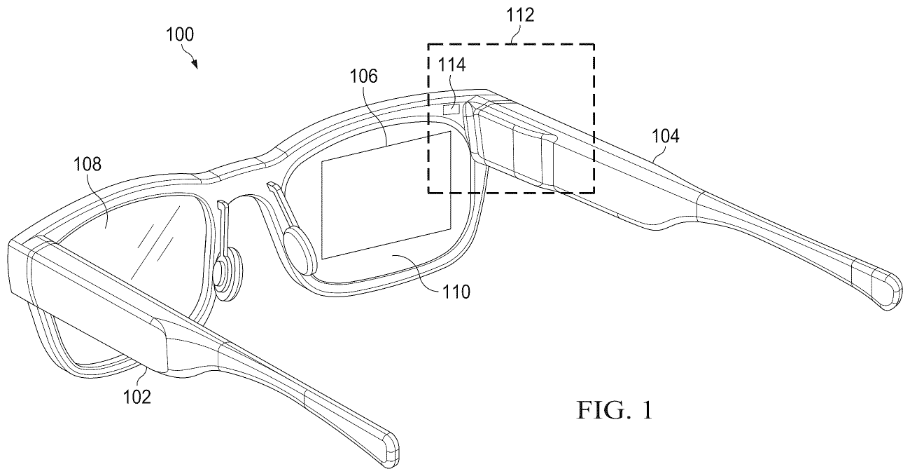

FIGS. 1-10 illustrate systems and techniques for collimating light generated by a light engine for coupling to a waveguide using a penta prism collimator having four freeform surfaces that fold the optical path of the light, resulting in a compact design. A penta prism is a five-sided reflecting prism that reflects a beam of light inside the prism twice, allowing the transmission of an image through a right angle without inverting the image. The term “freeform” refers to a surface that does not have symmetry around any axis. In some embodiments, the freeform surfaces are toroidal surfaces made from a single injection-molded element, such as a single piece of plastic. The freeform surfaces collimate the light at a variety of distances from an input pupil of a waveguide, allowing for more freedom of placement within a frame of a WHUD. In some embodiments, a field flattener lens (referred to as a field flattener) is disposed between a microdisplay and a first freeform surface of the penta prism collimator to shift a focal length to increase the FOV. For a waveguide display system, the FOV provided for the wavelengths being directed by the system is a key parameter for evaluating its optical performance. In some embodiments, one or more of the freeform surfaces of the penta prism collimator is coated with a light absorbing surface to mitigate artifacts.

FIG. 1 illustrates an example near-eye display system 100 (referred to as display system 100) employing a freeform penta prism collimator 114 in accordance with some embodiments. The display system 100 has a support structure 102 that includes an arm 104, which houses a projector (e.g., a laser projector, a micro-LED projector, a Liquid Crystal on Silicon (LCOS) projector, or the like), also referred to herein as a microdisplay. The projector is configured to project images toward the eye of a user via a lightguide, such that the user perceives the projected images as being displayed in a field of view (FOV) area 106 of a display at one or both of spherical lens elements 108, 110. In the depicted embodiment, the display system 100 is a near-eye display system in the form of a WHUD in which the support structure 102 is configured to be worn on the head of a user and has a general shape and appearance (that is, form factor) of an eyeglasses (e.g., sunglasses) frame.

The support structure 102 contains or otherwise includes various components to facilitate the projection of such images toward the eye of the user, such as a projector and a lightguide. In some embodiments, the support structure 102 further includes various sensors, such as one or more front-facing cameras, rear-facing cameras, other light sensors, motion sensors, accelerometers, and the like. In some embodiments, the support structure 102 includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1. It should be understood that instances of the term “or” herein refer to the non-exclusive definition of “or”, unless noted otherwise. For example, herein the phrase “X or Y” means “either X, or Y, or both”.

One or both of the spherical lens elements 108, 110 are used by the display system 100 to provide an augmented reality (AR) display in which rendered graphical content can be superimposed over or otherwise provided in conjunction with a real-world view as perceived by the user through the spherical lens elements 108, 110. For example, a projection system of the display system 100 uses light to form a perceptible image or series of images by projecting the light onto the eye of the user via a projector of the projection system, the freeform penta prism collimator 114, a lightguide formed at least partially in the corresponding spherical lens element 108 or 110, and one or more optical elements (e.g., one or more scan mirrors, or one or more optical relays, that are disposed between the projector and the lightguide), according to various embodiments.

One or both of the spherical lens elements 108, 110 includes at least a portion of a lightguide that routes display light received by an incoupler of the lightguide to an outcoupler of the lightguide, which outputs the display light toward an eye of a user of the display system 100. The display light is modulated and projected onto the eye of the user such that the user perceives the display light as an image. In addition, each of the spherical lens elements 108, 110 is sufficiently transparent to allow a user to see through the spherical lens elements to provide a field of view of the user's real-world environment such that the image appears superimposed over at least a portion of the real-world environment.

In some embodiments, the projector of the projection system of the display 100 is a digital light processing-based projector, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, the projector includes a micro-display panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the projector includes a Liquid Crystal on Silicon (LCOS) display panel. In some embodiments, a display panel of the projector is configured to output light (representing an image or portion of an image for display) into the lightguide of the display system via the freeform penta prism collimator 114. The lightguide expands the light and outputs the light toward the eye of the user via an outcoupler.

The display system 100 may include a processor (not shown) that is communicatively coupled to each of the electrical components in the display system 100, including but not limited to the projector. The processor can be any suitable component which can execute instructions or logic, including but not limited to a micro-controller, microprocessor, multi-core processor, integrated-circuit, ASIC, FPGA, programmable logic device, or any appropriate combination of these components. The display system 100 can include a non-transitory processor-readable storage medium, which may store processor readable instructions thereon, which when executed by the processor can cause the processor to execute any number of functions, including causing the projector to output light representative of display content to be viewed by a user, receiving user input, managing user interfaces, generating display content to be presented to a user, receiving and managing data from any sensors carried by the display system 100, receiving and processing external data and messages, and any other functions as appropriate for a given application. The non-transitory processor-readable storage medium can be any suitable component, which can store instructions, logic, or programs, including but not limited to non-volatile or volatile memory, read only memory (ROM), random access memory (RAM), FLASH memory, registers, magnetic hard disk, optical disk, or any combination of these components. The projector outputs light toward the FOV area 106 of the display system 100 via the lightguide.

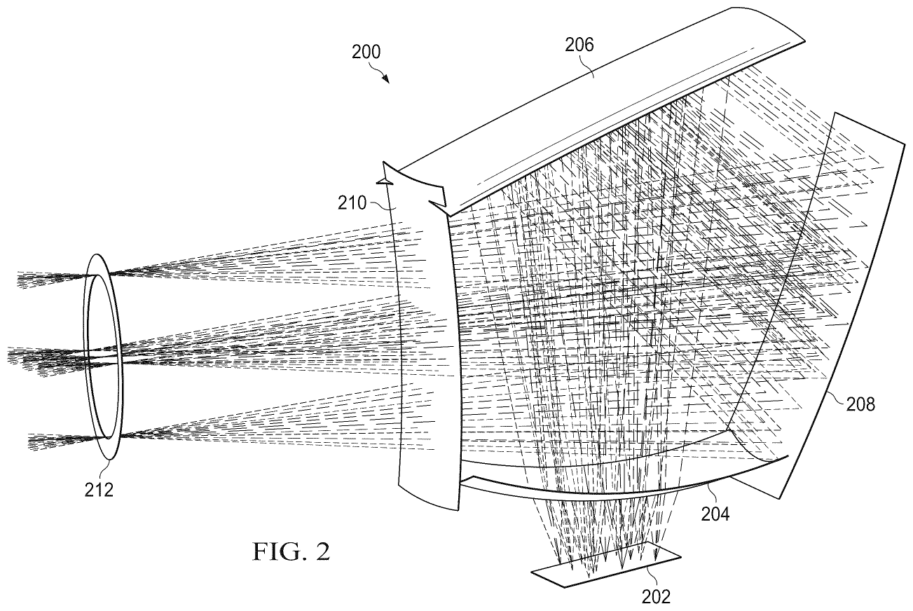

FIG. 2 shows an example freeform penta prism collimator 200 in accordance with some embodiments. The freeform penta prism collimator 200 includes a first freeform surface 204, a second freeform surface 206, a third freeform surface 208, and a fourth freeform surface 210. The freeform penta prism collimator 200 steers light from a microdisplay, such as microdisplay 202, into an incoupler of a lightguide so that light is coupled into the incoupler with substantially parallel beams at the appropriate angle to encourage propagation of the light in the lightguide by total internal reflection (TIR). In some embodiments, at least one of the first freeform surface 204, the second freeform surface 206, the third freeform surface 208, and the fourth freeform surface 210 is a toroid. In the illustrated example, the first freeform surface 204 is disposed opposite the second freeform surface 206 and adjacent to the third freeform surface 208 and the fourth freeform surface 210, which are disposed opposite each other.

In operation, light emitted from the microdisplay 202 refracts through the first freeform surface 204. The light is then reflected off the second freeform surface 206 toward the third freeform surface 208. The third freeform surface 208 receives light reflected off the second freeform surface 206 and in turn reflects the light toward the fourth freeform surface 210. The fourth freeform surface 210 refracts the light received from the third freeform surface 208 out of the freeform penta prism collimator 200 toward an input pupil 212 in substantially parallel beams.

In some embodiments, the shapes of each of the first freeform surface 204, the second freeform surface 206, the third freeform surface 208, and the fourth freeform surface 210 are described by a height (also referred to as a sag) z from each point (x,y) along a plane, wherein r is a base sphere term and j is an index:

$$z = \frac{c {r}^{2}}{1 + \sqrt{1 - ( 1 + k ) {c}^{2} {r}^{2}}} + {\sum }_{j = 2}^{66} {C}_{j} {x}^{m} {y}^{n} \qquad ( 1 )$$

$$where$$

$$j = \frac{{( m + n )}^{2} + m + 3 n}{2} + 1 \qquad ( 2 )$$

Thus, for example, in the case of a toroid, if m=2 and n=0, j=4, and if m=0 and n=2, j=6. In some embodiments, the coefficients used in equations (1) and (2) differ for each of the first freeform surface 204, the second freeform surface 206, the third freeform surface 208, and the fourth freeform surface 210.

In some embodiments, the values of the terms for equation (1) for each of the first freeform surface 204, the second freeform surface 206, the third freeform surface 208, and the fourth freeform surface 210 are shown in Table 1 below.

TABLE 1

| Surface | Base radius of curvature |
|---|---|
| First freeform surface 204 | x² term: −1.1202E−02 |
| | y² term: −1.3115E−02 |
| Second freeform surface 206 | x² term: 4.6999E−02 |
| | y² term: 3.7742E−02 |
| Third freeform surface 208 | x² term: −4.9403E−02 |
| | y² term: −1.4024E−02 |
| Fourth freeform surface 210 | x² term: 1.1457E−02 |
| | y² term: −2.6992E−02 |

The first freeform surface 204, the second freeform surface 206, the third freeform surface 208, and the fourth freeform surface 210 are sized and spaced relative to one another such that substantially all of the light rays emitted by the microdisplay 202 propagate through the freeform penta prism collimator 200 and are emitted in substantially parallel rays through the fourth freeform surface 210 to an input pupil 212. The first freeform surface 204, the second freeform surface 206, the third freeform surface 208, and the fourth freeform surface 210 are further sized and spaced relative to one another to yield a desired focal length.

In some embodiments, the freeform penta prism collimator 200 emits light in substantially parallel rays over a range of distances to the input pupil 212, such that an incoupler of a lightguide can be placed at a variety of distances from the freeform penta prism collimator 200. For example, in some embodiments, the input pupil 212 has a diameter of 3 mm and the freeform penta prism collimator 200 can be placed anywhere from 1 mm to 6 mm from the input pupil 212 while providing a 20×15 degree FOV.

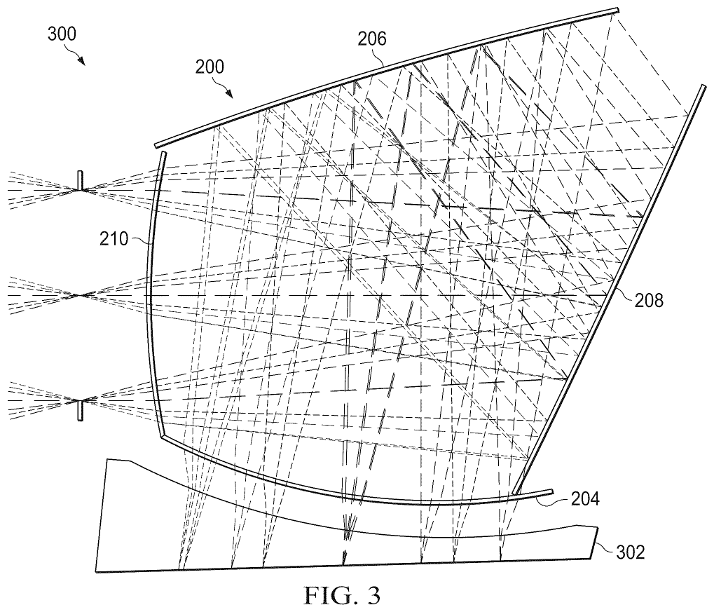

FIG. 3 shows an example collimating system 300 including the freeform penta prism collimator 200 and a spherical field flattener 302 in accordance with some embodiments. The field flattener 302 is a lens that counters the field-angle dependence of the focal length of the system 300 by adding a negative optical power to mitigate astigmatism and variation of astigmatism with color at the image plane. The addition of the field flattener 302 to the collimating system 300 improves optical performance as measured by a modulation transfer function and increases the field of view. For example, in some embodiments, the freeform penta prism collimator 200 yields a 20×15 degree FOV, whereas the collimating system 300 that includes the field flattener 302 yields a 30×30 degree FOV. In some embodiments, the freeform penta prism collimator 200 is formed from a single injection-molded element, such as a single piece of plastic. In other embodiments, the freeform penta prism collimator 200 is an assembly of multiple pieces of one or more materials, such as glass or other components having different indices of refraction. In some embodiments, the spherical field flattener 302 is attached to the freeform penta prism collimator 200.

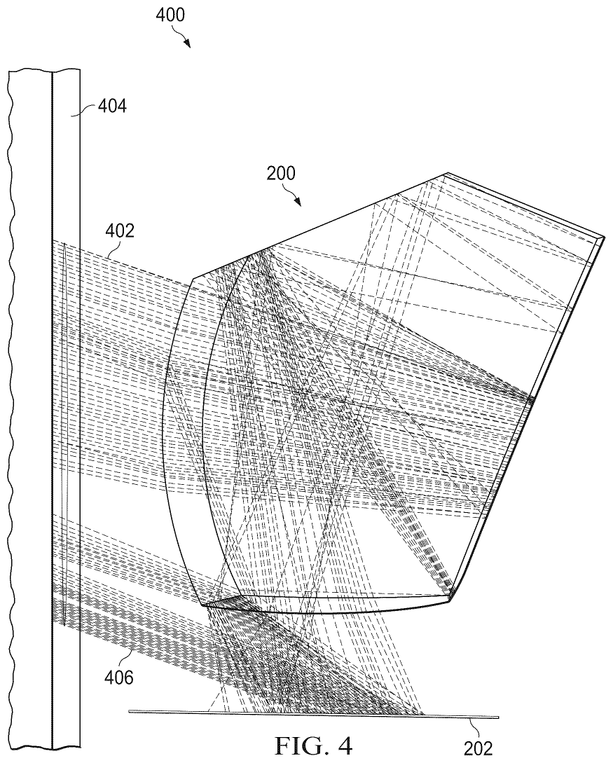

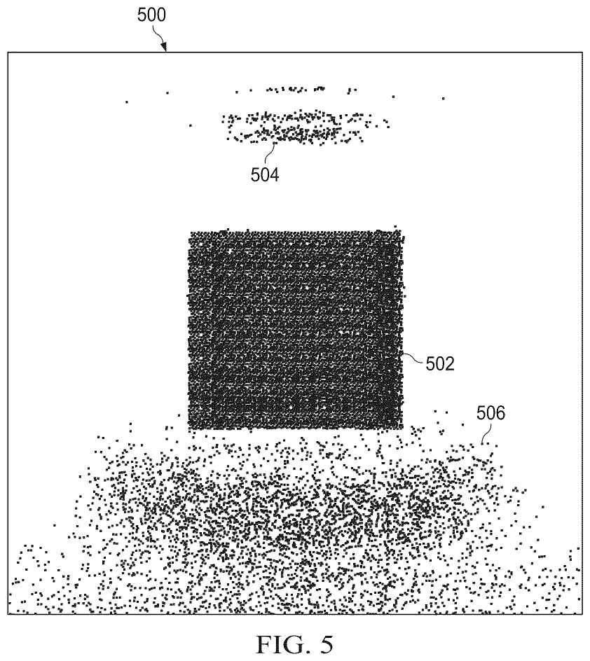

FIG. 4 shows the freeform penta prism collimator 200 without artifact mitigation in accordance with some embodiments. Light emitted from the microdisplay 202 enters the freeform penta prism collimator 200, where it undergoes multiple reflections. Some of the reflections result in light 402 that is output to an image plane 404 and forms a main image. However, some of the reflections result in light 406 that is output to the image plane and does not form the main image but instead forms artifacts that are visible above and below the main image, as illustrated in FIG. 5.

FIG. 5 shows an example of a display image 500 without artifact mitigation in accordance with some embodiments. The display image 500 includes a main image 502 that is formed by, e.g., light 402 of FIG. 4. The display image 500 further includes artifacts 504 above the main image 502 and artifacts 506 below the main image 502. In addition, the main image 502 is blurred by the inclusion of artifacts. Artifacts 504, 506 are formed by, e.g., light 406 of FIG. 4. Such artifacts negatively impact the user experience by clouding the main image 502 and creating visible “clouds” of light above and below the main image 502.

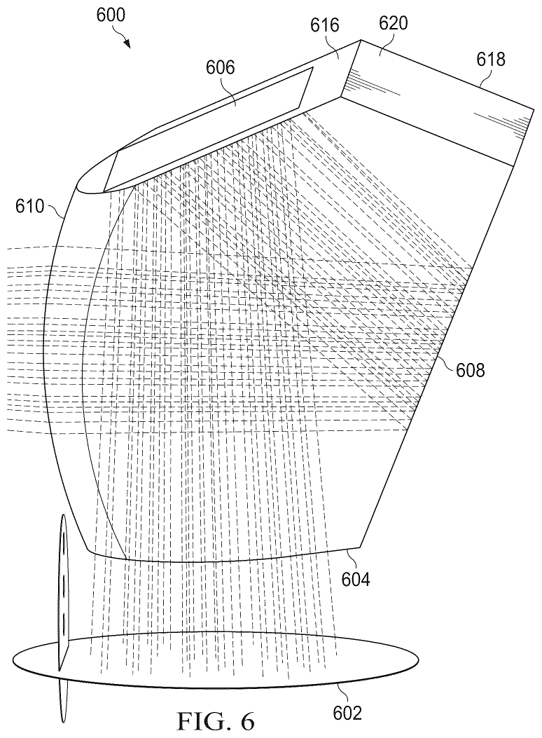

To reduce the appearance of artifacts within and around the main image 502, artifact mitigation techniques are applied to the freeform penta prism collimator. FIG. 6 shows an example freeform penta prism collimator 600 with artifact mitigation in accordance with some embodiments. The freeform penta prism collimator 600 includes a first freeform surface 604, a second freeform surface 606, a third freeform surface 608, a fourth freeform surface 610, and a fifth surface 618. The freeform penta prism collimator 600 steers light from a microdisplay, such as microdisplay 602, into an incoupler of a lightguide so that light is coupled into the incoupler with substantially parallel beams.

In the illustrated example, the first freeform surface 604 is disposed opposite the second freeform surface 606 and adjacent to the third freeform surface 608 and the fourth freeform surface 610, which are disposed opposite each other. The fifth surface 618 is disposed between the second freeform surface 606 and the third freeform surface 608. In operation, light emitted from the microdisplay 602 refracts through the first freeform surface 604. The light is then reflected off the second freeform surface 606 toward the third freeform surface 208. The third freeform surface 608 receives light reflected off the second freeform surface 606 and in turn reflects the light toward the fourth freeform surface 610. The fourth freeform surface 610 refracts the light received from the third freeform surface 608 out of the freeform penta prism collimator 600 toward an input pupil (not shown) in substantially parallel beams.

To mitigate artifacts, the second freeform surface 606 is coated with a light absorbing surface 616 and the fifth surface 618 is coated with a light absorbing surface 620. In some embodiments, the light absorbing surfaces 616, 620 are the same surface, such as, e.g., a black coating. The light absorbing surfaces 616, 620 absorb light rays that would otherwise refract out of the second freeform surface 606 and the fifth surface 618, thus preventing re-reflection of those light rays and the consequent appearance of artifacts within and around a main image.

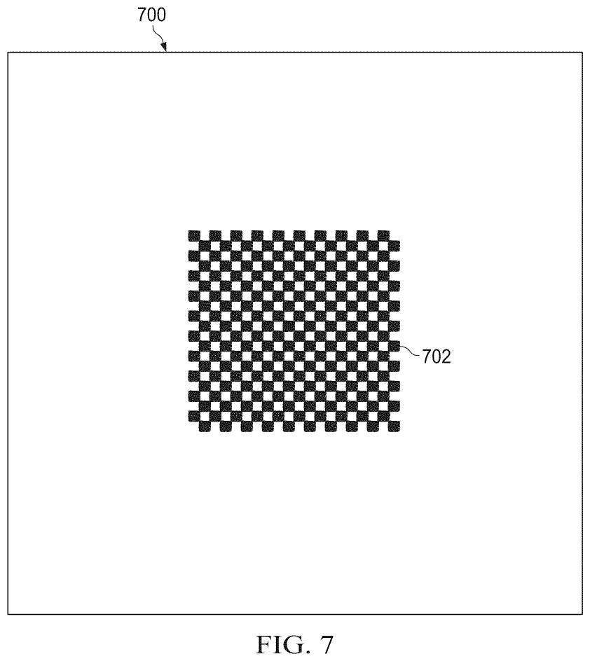

FIG. 7 shows an example of a display image 700 with artifact mitigation in accordance with some embodiments. The display image 700 includes a main image 702 that shows a clear checkerboard pattern and no artifacts above or below the main image 702.

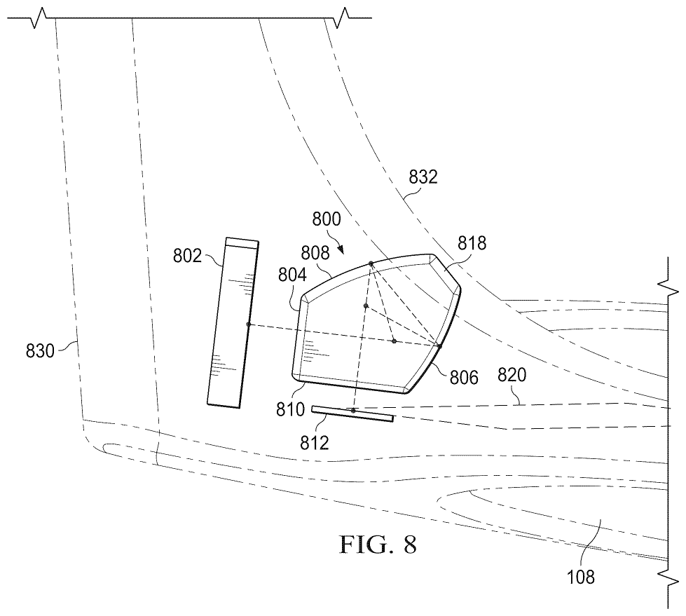

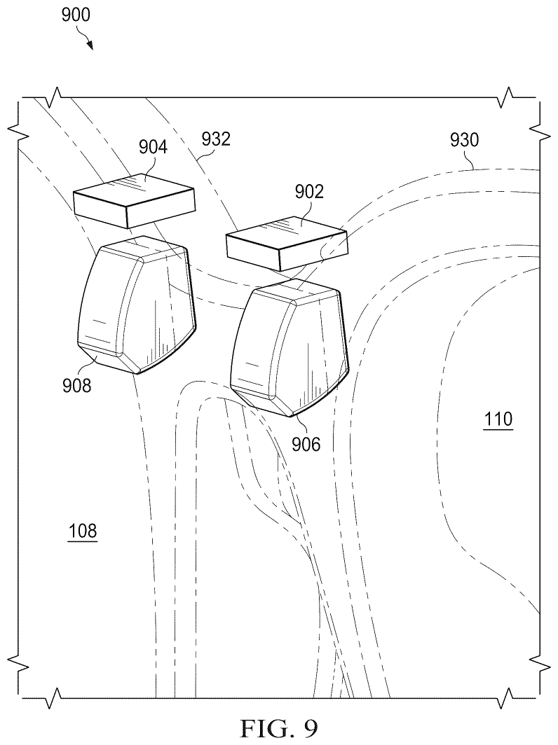

FIGS. 8 and 9 show two different perspectives of partially transparent views of a portion of a wearable heads up display (WHUD) 830 such as display system 100. The WHUD 830 includes an example arrangement of the freeform penta prism collimator 200 of FIGS. 2, 3, and 4 for an embodiment in which the freeform penta prism collimator 800 is disposed between a microdisplay 802 and an incoupler 812 of a waveguide 820. In some embodiments, the WHUD 830 corresponds to the display system 100 of FIG. 1, and the illustrated portion of the WHUD 830 corresponds to the region 112 of the display system 100.

As shown by the view of FIG. 8, the frame 832 of the WHUD 830 houses the microdisplay 802, the lens element 108, the waveguide 820, and the freeform penta prism collimator 800. As shown by the view of FIG. 8, the waveguide 820 (not fully shown in the view of FIG. 8), is embedded in or otherwise disposed on the lens 108. As described previously, light output by the microdisplay 802 is routed to the incoupler 812 via the freeform penta prism collimator 800. Light emitted from the microdisplay 802 refracts through a first freeform surface 804. The light is then reflected off a second freeform surface 806 toward a third freeform surface 808. The third freeform surface 808 receives light reflected off the second freeform surface 806 and in turn reflects the light toward a fourth freeform surface 810. The fourth freeform surface 810 refracts the light received from the third freeform surface 808 out of the freeform penta prism collimator 800 toward an input pupil of the incoupler 812 in substantially parallel beams. Laser light or light from a microdisplay received at the incoupler 812 is routed to an outcoupler (not shown) via the waveguide 820. The light received at the outcoupler is then directed out of the waveguide 820 (e.g., toward the eye of a user of the WHUD 830).

In some embodiments, a field flattener such as the spherical field flattener 302 illustrated in FIG. 3 is included between the microdisplay 802 and the first surface 804 of the freeform penta prism collimator 800 to increase the FOV. Alternatively or additionally, in some embodiments, one or both of the second freeform surface 806 and a fifth freeform surface 818 are coated with a light absorbing surface to mitigate the appearance of artifacts.

FIG. 9 shows an example placement of two freeform penta prism collimators within an example HMD 930 in accordance with some embodiments. The WHUD 830 includes an example arrangement of the freeform penta prism collimator 200 of FIGS. 2, 3, and 4 for an embodiment in which a first freeform penta prism collimator 906 is disposed between a first microdisplay 902 and a first incoupler (not shown) of a lightguide and a second freeform penta prism collimator 908 is disposed between a second microdisplay 904 and a second incoupler (not shown) of a second lightguide. In some embodiments, the WHUD 930 corresponds to the display system 100 of FIG. 1, and the illustrated portion of the WHUD 930 corresponds to a nose bridge region of the display system 100.

As shown by the view 900 of FIG. 9, one side of the frame 932 of the WHUD 930 houses the first microdisplay 902, the lens element 110, and the first freeform penta prism collimator 906 and the other side of the frame 932 of the WHUD 930 houses the second microdisplay 904, the lens element 108, and the second freeform penta prism collimator 908. Lightguides (not shown in the views of FIG. 9), are embedded in or otherwise disposed on the lenses 108, 110. As described previously, light output by the microdisplays 902, 904 is routed to the respective incouplers of the lightguides via the freeform penta prism collimators 906, 908.

In some embodiments, a field flattener such as the spherical field flattener 302 illustrated in FIG. 3 is included between at least one of the first microdisplay 902 and the first freeform penta prism collimator 906 and the second microdisplay 904 and the second freeform penta prism collimator 908 to increase the FOV. Alternatively or additionally, in some embodiments, one or both of the second freeform surface and the fifth freeform surface of each of the first freeform penta prism collimator 906 and the second freeform penta prism collimator 908 are coated with a light absorbing surface to mitigate the appearance of artifacts.

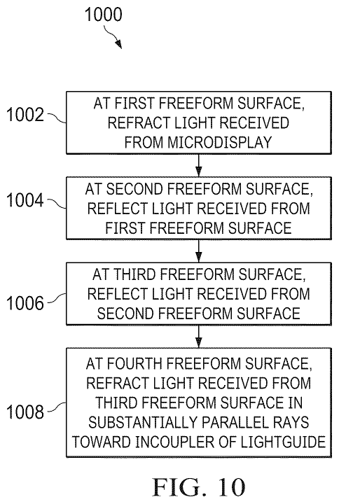

FIG. 10 is a flow diagram of a method 1000 of directing light within a freeform penta prism collimator to produce collimated light at an input pupil of a waveguide in accordance with some embodiments. In some embodiments, the method 1000 is performed, at least in part, by an embodiment of the freeform penta prism collimators 200, 600, 800, 906, and 908 of FIGS. 2, 3, 4, 6, 8, and 9 and the near-eye display system 100 of FIG. 1.

At block 1002, light received from a microdisplay such as microdisplay 202, 602, 802, 902, and 904 is refracted by the first freeform surface 204 toward the second freeform surface 206. At block 1004, the second freeform surface 206 reflects light received from the first freeform surface 204 toward the third freeform surface 208.

At block 1006, the third freeform surface 208 reflects light received from the second freeform surface 206 toward the fourth freeform surface 210. At block 1008, the fourth freeform surface 210 refracts light received from the third freeform surface 208 in substantially parallel rays toward an incoupler of a lightguide.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A device, comprising:
a prism collimator comprising:
a first freeform surface to refract light received from a microdisplay;
a second freeform surface to reflect light received from the first freeform surface;
a third freeform surface to reflect light received from the second freeform surface; and
a fourth freeform surface to refract light received from the third freeform surface in substantially parallel rays.

2. The device of claim 1, wherein at least one of the first, second, third, and fourth freeform surfaces is a toroid.

3. The device of claim 1, wherein the first, second, third, and fourth freeform surfaces are formed from a single piece of plastic.

4. The device of claim 1, wherein the first, second, third, and fourth freeform surfaces are injection molded.

5. The device of claim 1, further comprising a field flattener disposed between the microdisplay and the first freeform surface.

6. The device of claim 1, wherein the fourth freeform surface refracts light in substantially parallel rays at varying distances to an input pupil.

7. The device of claim 1, wherein at least one of the first, second, third, and fourth freeform surfaces is coated with a light absorbing surface.

8. A system, comprising:
a microdisplay to generate light;
a waveguide; and
a prism collimator to collimate light generated by the microdisplay for transmission to the waveguide, the prism collimator comprising:
a first freeform surface to refract light received from the microdisplay;
a second freeform surface to reflect light received from the first freeform surface;
a third freeform surface to reflect light received from the second freeform surface; and
a fourth freeform surface to refract light received from the third freeform surface in substantially parallel rays toward the waveguide.

9. The system of claim 8, wherein at least one of the first, second, third, and fourth freeform surfaces is a toroid.

10. The system of claim 8, wherein the first, second, third, and fourth freeform surfaces are formed from a single piece of plastic.

11. The system of claim 8, wherein the first, second, third, and fourth freeform surfaces are injection molded.

12. The system of claim 8, further comprising a field flattener disposed between the microdisplay and the first freeform surface.

13. The system of claim 8, wherein the fourth freeform surface refracts light in substantially parallel rays at varying distances to an input pupil.

14. The system of claim 8, wherein at least one of the first, second, third, and fourth freeform surfaces is coated with a light absorbing surface.

15. A method, comprising:
refracting light received from a microdisplay at a first freeform surface of a prism collimator;
reflecting light received from the first freeform surface at a second freeform surface of the prism collimator;
reflecting light received from the second freeform surface at a third freeform surface of the prism collimator; and
at a fourth freeform surface of the prism collimator, refracting light received from the third freeform surface in substantially parallel rays.

16. The method of claim 15, wherein at least one of the first, second, third, and fourth freeform surfaces is a toroid.

17. The method of claim 15, wherein the first, second, third, and fourth freeform surfaces are injection molded.

18. The method of claim 15, further comprising:
shifting a focal length of light received from the microdisplay at a field flattener disposed between the microdisplay and the first freeform surface.

19. The method of claim 15, further comprising:
refracting light in substantially parallel rays at varying distances to an input pupil at the fourth freeform surface.

20. The method of claim 15, wherein at least one of the first, second, third, and fourth freeform surfaces is coated with a light absorbing surface.
